(19) United States
(12) Patent Application Publication
(10) Pub. No.: US 2026/0344747 A1
(43) Pub. Date: Nov. 5, 2026

(54) AEROSOL-GENERATING ARTICLE AND SYSTEM

(71) Applicant: Philip Morris Products S.A., Neuchatel (CH)

(72) Inventors: Rui Nuno Rodrigues Alves BATISTA, Morges (CH); Semen GURALEVYCH, Lausanne (CH)

(73) Assignee: Philip Morris Products S.A., Neuchatel (CH)

(21) Appl. No.: 19/136,942

(22) PCT Filed: Dec. 21, 2023
(86) PCT No.: PCT/EP2023/087274

§ 371 Date: Jun. 9, 2025

(30) Foreign Application Priority Data
Dec. 23, 2022 (EP) 22216422.0

(51) Int. Cl. A24D 1/20; A24F 40/20

(52) U.S. Cl. CPC A24D 1/20; A24F 40/20

(57) ABSTRACT

An aerosol-generating article for an aerosol-generating device to generate an aerosol is provided, the article including: an inlet, outlet, and flow passage extending from the inlet to the outlet; a first aerosol-generating segment including a first aerosol-generating substrate and being located in the passage; and a second aerosol-generating segment including a second aerosol-generating substrate being located in the passage, the article being planar and having a length, width, and thickness being no more than 0.5 times the length and the width, part of the second segment being located upstream of part of the first segment, and an aerosol former content of the second substrate being at least 1.1 times that of the first substrate by weight on a dry weight basis and/or a bulk density of the second substrate being at least 1.1 times that of the first substrate.

The present disclosure relates to an aerosol-generating article and an aerosol-generating system comprising an aerosol-generating device and an aerosol-generating article.

A typical aerosol-generating system comprises an aerosol-generating device and an aerosol-generating article comprising an aerosol-generating substrate. In use, the aerosol-generating device heats a heating element which is near, or in contact with, the aerosol-generating substrate, causing heating of the aerosol-generating substrate and the release of volatile compounds from the aerosol-generating substrate. These compounds then cool to form an aerosol which is inhaled by a user.

Such aerosol-generating articles in which an aerosol-generating substrate is heated rather than combusted present a number of challenges that were not encountered with conventional cigarettes.

Firstly, aerosol-generating substrates are typically heated to significantly lower temperatures compared with the temperatures reached by combustion in a conventional cigarette. This may have an impact on the release of certain volatile compounds, such as nicotine, from the aerosol-generating substrate and their delivery to the user. At the same time, if the heating temperature is increased in an attempt to boost delivery of those volatile compounds, then there may be a risk of burning the substrate, and the aerosol generated would need to be cooled to a greater extent and more rapidly before it reached the user.

Secondly, heating an aerosol-generating substrate to the temperature required for aerosol formation takes a certain amount of time, and so there may be a delay in aerosol delivery to the user after heating has been initiated. This phenomenon, whereby a user initially draws upon an aerosol-generating article and the aerosol reaching the user is relatively low in flavour or certain volatile compounds such as nicotine, is often referred to as “cold puff” effect or “empty puff” effect.

It is an aim of the present invention to provide an improved aerosol-generating article, for example one which addresses one or both of the above challenges, particularly one which may be able to provide more consistent delivery of volatile compounds during a puffing session.

According to the present disclosure, there is provided an aerosol-generating article for use with an aerosol-generating device to generate an aerosol. The aerosol-generating article may comprise an inlet, an outlet, and a flow passage extending from the inlet to the outlet. The article may comprise a first aerosol-generating segment comprising a first aerosol-generating substrate. The first aerosol-generating segment may be located in the flow passage. The article may comprise a second aerosol-generating segment comprising a second aerosol-generating substrate. The second aerosol-generating segment may be located in the flow passage. The aerosol-generating article may be a planar aerosol-generating article. The article may have a length, a width, and a thickness. The thickness may be no more than 0.5, preferably no more than 0.2, times the length. The thickness may be no more than 0.5, preferably no more than 0.2, times the width. The first aerosol-generating substrate may have one or both of a lower aerosol former content and a lower bulk density than the second aerosol-generating substrate.

Thus, according to a first aspect of the present disclosure, there is provided an aerosol-generating article for use with an aerosol-generating device to generate an aerosol, the aerosol-generating article comprising: an inlet, an outlet, and a flow passage extending from the inlet to the outlet; a first aerosol-generating segment comprising a first aerosol-generating substrate, the first aerosol-generating segment being located in the flow passage; and a second aerosol-generating segment comprising a second aerosol-generating substrate, the second aerosol-generating segment being located in the flow passage. The aerosol-generating article is a planar aerosol-generating article having a length, a width, and a thickness, the thickness being no more than 0.5 times the length and no more than 0.5 times the width. The first aerosol-generating substrate has one or both of a lower aerosol former content and a lower bulk density than the second aerosol-generating substrate.

The article of the first aspect is a planar article, and the first aerosol-generating substrate has one or both of a lower aerosol former content and a lower bulk density than the second aerosol-generating substrate.

The article being planar may allow a quick transfer of heat from a heating element, such as a planar heating element, to the first aerosol-generating substrate, thus reducing the time taken from initiating heating to aerosol generation.

The first aerosol-generating substrate having one or both of a lower aerosol former content and a lower bulk density than the second aerosol-generating substrate may allow the first aerosol-generating substrate to heat up faster due to the first aerosol-generating substrate having a lower thermal inertia. This may allow the first aerosol-generating substrate to start generating aerosol within a relatively short time, thus reducing the time taken from initiating heating to aerosol generation.

Thus, advantageously, these features may work synergistically together to reduce the time it takes from initiating heating to aerosol generation.

The first and second aerosol-generating substrates may comprise the same aerosol former or aerosol formers as each other, or different aerosol formers may be used.

The first and second aerosol-generating substrates may comprise or consist of the first and second aerosol-generating substrates, respectively. The first and second aerosol-generating substrates may comprise non-aerosol-generating material as well as aerosol-generating material.

Optionally, the aerosol former content of the first aerosol-generating substrate is at least 10 percent by weight on a dry weight basis. Optionally, the aerosol former content of the first aerosol-generating substrate is no more than 30, 25 or 20 percent by weight on a dry weight basis. Optionally, the aerosol former content of the first aerosol-generating substrate is between 10 and 30 percent, preferably between 10 and 25 percent, more preferably between 10 and 20 percent, by weight on a dry weight basis.

Advantageously, such aerosol former content in the first aerosol-generating substrate may provide a good compromise between allowing the first aerosol-generating substrate to generate aerosol quickly and being able to generate a sufficient quantity of aerosol.

Optionally, the aerosol former content of the second aerosol-generating substrate is at least 40, 45, or 50 percent by weight on a dry weight basis. Optionally, the aerosol former content of the second aerosol-generating substrate is no more than 80, 75 or 70 percent by weight on a dry weight basis. Optionally, the aerosol former content of the second aerosol-generating substrate is between 40 and 80 percent, preferably between 45 and 75 percent, more preferably between 50 and 70 percent, by weight on a dry weight basis.

Since the first aerosol-generating substrate may have a relatively small aerosol former content, it may be depleted relatively quickly. As such, it may be advantageous for the second aerosol-generating substrate to have a relatively high aerosol former content. In this way, the first aerosol-generating substrate may be heated quickly to provide aerosol for earlier puffs during a usage session, and the second aerosol-generating substrate may take longer to heat up but then provide aerosol for later puffs during a usage session, after the first aerosol-generating substrate has been depleted.

Optionally, the aerosol former content of the second aerosol-generating substrate is at least 1.1, 1.2, 1.5, 2 or 2.5 times the aerosol former content of the first aerosol-generating substrate by weight on a dry weight basis. Optionally, the aerosol former content of the second aerosol-generating substrate is no more than 10, 8, or 6 times the aerosol former content of the first aerosol-generating substrate.

Optionally, by weight on a dry weight basis, the aerosol former content of the second aerosol-generating substrate is X percent and the aerosol former content of the first aerosol-generating substrate is Y percent, and X is at least 5, 10 or 20 greater than Y.

Optionally, the aerosol former content of the first aerosol-generating substrate is no more than 30 percent by weight on a dry weight basis, and the aerosol former content of the second aerosol-generating substrate is at least 40 percent by weight on a dry weight basis. Preferably, the aerosol former content of the first aerosol-generating substrate is no more than 25 percent by weight on a dry weight basis, and the aerosol former content of the second aerosol-generating substrate is at least 45 percent by weight on a dry weight basis. More preferably, the aerosol former content of the first aerosol-generating substrate is no more than 20 percent by weight on a dry weight basis, and the aerosol former content of the second aerosol-generating substrate is at least 50 percent by weight on a dry weight basis.

Optionally, the first aerosol-generating substrate has a bulk density of at least 100, 150 or 200 milligrams per cubic centimetre. Optionally, the first aerosol-generating substrate has a bulk density of no more than 400, 350 or 300 milligrams per cubic centimetre. Optionally, the first aerosol-generating substrate has a bulk density of between 100 and 400 milligrams per cubic centimetre, preferably between 150 and 350 milligrams per cubic centimetre.

Advantageously, such a bulk density of the first aerosol-generating substrate may provide a good compromise between allowing the first aerosol-generating substrate to generate aerosol quickly and being able to generate a sufficient quantity of aerosol.

Optionally, the second aerosol-generating substrate has a bulk density of at least 500, 550 or 600 milligrams per cubic centimetre. Optionally, the second aerosol-generating substrate has a bulk density of no more than 1000, 900 or 800 milligrams per cubic centimetre. Optionally, the second aerosol-generating substrate has a bulk density of between 500 and 1000 milligrams per cubic centimetre, preferably between 550 and 900 milligrams per cubic centimetre.

Since the first aerosol-generating substrate may have a relatively small bulk density, it may be depleted relatively quickly. As such, it may be advantageous for the second aerosol-generating substrate to have a relatively high bulk density. In this way, the first aerosol-generating substrate may be heated quickly to provide aerosol for earlier puffs during a usage session, and the second aerosol-generating substrate may take longer to heat up but then provide aerosol for later puffs during a usage session, after the first aerosol-generating substrate has been depleted.

Optionally, the bulk density of the second aerosol-generating substrate is at least 1.1, 1.2, 1.5, 2 or 2.5 times the bulk density of the first aerosol-generating substrate. Optionally, the bulk density of the second aerosol-generating substrate is at least 20, 50, 100, or 200 milligrams per cubic centimetre greater than the bulk density of the first aerosol-generating substrate.

Optionally, the first aerosol-generating substrate has a bulk density of less than 400 milligrams per cubic centimetre, and the second aerosol-generating substrate has a bulk density of at least 500 milligrams per cubic centimetre. Preferably, the first aerosol-generating substrate has a bulk density of less than 350 milligrams per cubic centimetre, and the second aerosol-generating substrate has a bulk density of at least 550 milligrams per cubic centimetre. More preferably, the first aerosol-generating substrate has a bulk density of less than 300 milligrams per cubic centimetre, and the second aerosol-generating substrate has a bulk density of at least 600 milligrams per cubic centimetre.

Optionally, the first aerosol-generating substrate has both a lower aerosol former content and a lower bulk density than the second aerosol-generating substrate. Advantageously, the first aerosol-generating substrate having both a lower aerosol former content and a lower bulk density than the second aerosol-generating substrate may exaggerate the benefits explained above. That is, this may allow the first aerosol-generating substrate to heat up and generate an aerosol quickly, and the second aerosol-generating substrate to heat up slowly and continue to generate aerosol after the first aerosol-generating substrate has been depleted.

Optionally, the aerosol former content of the second aerosol-generating substrate is at least 1.1 times the aerosol former content of the first aerosol-generating substrate by weight on a dry weight basis, and the bulk density of the second aerosol-generating substrate is at least 1.1 times the bulk density of the first aerosol-generating substrate. Preferably, the aerosol former content of the second aerosol-generating substrate is at least 1.2 times the aerosol former content of the first aerosol-generating substrate by weight on a dry weight basis, and the bulk density of the second aerosol-generating substrate is at least 1.2 times the bulk density of the first aerosol-generating substrate. More preferably, the aerosol former content of the second aerosol-generating substrate is at least 1.5 times the aerosol former content of the first aerosol-generating substrate by weight on a dry weight basis, and the bulk density of the second aerosol-generating substrate is at least 1.5 times the bulk density of the first aerosol-generating substrate. Even more preferably, the aerosol former content of the second aerosol-generating substrate is at least 2 times the aerosol former content of the first aerosol-generating substrate by weight on a dry weight basis; and the bulk density of the second aerosol-generating substrate is at least 2 times the bulk density of the first aerosol-generating substrate. Most preferably, the aerosol former content of the second aerosol-generating substrate is at least 2.5 times the aerosol former content of the first aerosol-generating substrate by weight on a dry weight basis; and the bulk density of the second aerosol-generating substrate is at least 2.5 times the bulk density of the first aerosol-generating substrate.

Optionally, the aerosol former content of the second aerosol-generating substrate is X percent by weight on a dry weight basis and the aerosol former content of the first aerosol-generating substrate is Y percent by weight on a dry weight basis, and X is at least 5 greater than Y; and the bulk density of the second aerosol-generating substrate is at least 50 milligrams per cubic centimetre greater than the bulk density of the first aerosol-generating substrate. Preferably, the aerosol former content of the second aerosol-generating substrate is X percent by weight on a dry weight basis and the aerosol former content of the first aerosol-generating substrate is Y percent by weight on a dry weight basis, and X is at least 10 greater than Y; and the bulk density of the second aerosol-generating substrate is at least 100 milligrams per cubic centimetre greater than the bulk density of the first aerosol-generating substrate. More preferably, the aerosol former content of the second aerosol-generating substrate is X percent by weight on a dry weight basis and the aerosol former content of the first aerosol-generating substrate is Y percent by weight on a dry weight basis, and X is at least 20 greater than Y; and the bulk density of the second aerosol-generating substrate is at least 200 milligrams per cubic centimetre greater than the bulk density of the first aerosol-generating substrate.

Optionally, the aerosol former content of the first aerosol-generating substrate is no more than 30 percent by weight on a dry weight basis, and the aerosol former content of the second aerosol-generating substrate is at least 40 percent by weight on a dry weight basis; and the first aerosol-generating substrate has a bulk density of less than 400 milligrams per cubic centimetre, and the second aerosol-generating substrate has a bulk density of at least 500 milligrams per cubic centimetre. Preferably, the aerosol former content of the first aerosol-generating substrate is no more than 25 percent by weight on a dry weight basis, and the aerosol former content of the second aerosol-generating substrate is at least 45 percent by weight on a dry weight basis; and the first aerosol-generating substrate has a bulk density of less than 350 milligrams per cubic centimetre, and the second aerosol-generating substrate has a bulk density of at least 550 milligrams per cubic centimetre. More preferably, the aerosol former content of the first aerosol-generating substrate is no more than 20 percent by weight on a dry weight basis, and the aerosol former content of the second aerosol-generating substrate is at least 50 percent by weight on a dry weight basis; and the first aerosol-generating substrate has a bulk density of less than 300 milligrams per cubic centimetre, and the second aerosol-generating substrate has a bulk density of at least 600 milligrams per cubic centimetre.

Optionally, at least a portion of the second aerosol-generating segment is located upstream of at least a portion of the first aerosol-generating segment. Optionally, the second aerosol-generating segment is located upstream of the first aerosol-generating segment. Optionally, an entirety of the second aerosol-generating segment is located upstream of an entirety the first aerosol-generating segment.

Once the aerosol has been generated from the first aerosol-generating substrate, the remaining depleted first aerosol-generating segment may have a relatively low weight and density. Thus, the second aerosol-generating segment being located upstream of the first aerosol-generating segment may be preferable to the other way around as this may advantageously mean that the first aerosol-generating segment provides a minimal level of filtration of the aerosol generated from the second, upstream aerosol-generating segment during the later puffs. This may enable a consistent delivery of aerosol to the user during the usage session.

Optionally, the second aerosol-generating segment is spaced from, for example upstream of, the first aerosol-generating segment by at least 0.5, 1 or 2 millimetres. Optionally, the second aerosol-generating segment is spaced from, for example upstream of, the first aerosol-generating segment by no more than 10, 5 or 2 millimetres. Optionally, the second aerosol-generating segment is spaced from, for example upstream of, the first aerosol-generating segment by between 0.5 and 5, preferably between 0.5 and 2, millimetres.

Advantageously, these spacings may provide a good compromise between the segments being sufficiently far apart that one can be heated without significant heating of the other, and the segments being sufficiently close together that no space is wasted and the overall length of the article is not excessive.

The first aerosol-generating segment may have a first length, a first width, and a first thickness. The first thickness may be no more than 0.5, preferably no more than 0.2, more preferably no more than 0.1, times the first length. The first thickness may be no more than 0.5, preferably no more than 0.2, more preferably no more than 0.1, times the first width.

The second aerosol-generating segment may have a second length, a second width, and a second thickness. The second thickness may be no more than 0.5, preferably no more than 0.2, more preferably no more than 0.1, times the second length. The second thickness may be no more than 0.5, preferably no more than 0.2, more preferably no more than 0.1, times the second width.

Advantageously, a thin, or planar, aerosol-generating segment may allow a greater proportion of the segment to be heated to a sufficient temperature to generate an aerosol more quickly. Alternatively, or in addition, a thin, or planar, aerosol-generating segment may allow a greater proportion of the substrate to be heated to a sufficiently high temperature to generate an aerosol, because less of the substrate may be located relatively far from the heater, so less substrate may be wasted.

Optionally, one or both of the first aerosol-generating segment and the second aerosol-generating segment is prismatic in shape, for example cuboid or right cylindrical in shape. Optionally, the first aerosol-generating segment and the second aerosol-generating segment are identical in shape.

Optionally, one or both of the first aerosol-generating segment and the second aerosol-generating segment has a thickness of at least 0.05, 0.1, or 0.2 millimetres. Optionally, one or both of the first aerosol-generating segment and the second aerosol-generating segment has a thickness no more than 5, 4, or 3 millimetres. Optionally, one or both of the first aerosol-generating segment and the second aerosol-generating segment has a thickness of between 0.1 and 5, preferably between 0.2 and 4, millimetres. Advantageously, such thicknesses may provide a good compromise between the segment being sufficiently thick to contain a reasonable quantity of aerosol-generating substrate, but sufficiently thin to allow substrate furthest from a heater to be heated to a sufficiently high temperature to generate an aerosol without a significant risk of burning the substrate closest to the heater.

Optionally, one or both of the first aerosol-generating segment and the second aerosol-generating segment has a width of at least 5 or 10 millimetres. Optionally, one or both of the first aerosol-generating segment and the second aerosol-generating segment has a width no more than 30 or 20 millimetres. Optionally, one or both of the first aerosol-generating segment and the second aerosol-generating segment has a width of between 10 and 20 millimetres.

Optionally, one or both of the first aerosol-generating segment and the second aerosol-generating segment has a length of at least 5 or 10 millimetres. Optionally, one or both of the first aerosol-generating segment and the second aerosol-generating segment has a length no more than 30 or 20 millimetres. Optionally, one or both of the first aerosol-generating segment and the second aerosol-generating segment has a length of between 10 and 20 millimetres.

Advantageously, such widths and lengths may comfortably fit within an article which is a comfortable size for a user to hold between their fingers, whilst still providing a sufficient quantity of substrate to generate enough aerosol to satisfy a user during a useage session. The first aerosol-generating substrate and the second aerosol-generating substrate may be formed of the same type of substrate as each other. Alternatively, the first aerosol-generating substrate and the second aerosol-generating substrate may be different types of material to each other.

Suitable types of materials for use in the first aerosol-generating substrate and the second aerosol-generating substrate are described below and include, for example, tobacco cut filler, homogenised tobacco material such as cast leaf, aerosol-generating films and gel compositions.

Preferably, the first aerosol-generating substrate comprises tobacco material. In certain preferred embodiments, the first aerosol-generating substrate comprises shredded tobacco material. For example, the shredded tobacco material may be in the form of cut filler, as described in more detail below. Alternatively, the shredded tobacco material may be in the form of a shredded sheet of homogenised tobacco material. Suitable homogenised tobacco materials are described below.

Within the context of the present specification, the term “cut filler” is used to describe to a blend of shredded plant material, such as tobacco plant material, including, in particular, one or more of leaf lamina, processed stems and ribs, homogenised plant material.

The cut filler may also comprise other after-cut, filler tobacco or casing.

Preferably, the cut filler comprises at least 25 percent of plant leaf lamina, more preferably, at least 50 percent of plant leaf lamina, still more preferably at least 75 percent of plant leaf lamina and most preferably at least 90 percent of plant leaf lamina. Preferably, the plant material is one of tobacco, mint, tea and cloves. Most preferably, the plant material is tobacco. However, other plant material may be used, for example other plant material that has the ability to release substances upon the application of heat that can subsequently form an aerosol.

Preferably, the cut filler comprises tobacco plant material comprising lamina of one or more of bright tobacco, dark tobacco, aromatic tobacco and filler tobacco. The term “tobacco” may refer to any plant member of the genus Nicotiana.

The cut filler may resemble cut filler used for conventional smoking articles. The cut width of the cut filler preferably may be between 0.3 millimetres and 2.0 millimetres, or between 0.5 millimetres and 1.2 millimetres, or between 0.6 millimetres and 0.9 millimetres.

Preferably, the strands have a length of between about 10 millimetres and about 40 millimetres before the strands are collated to form the aerosol-generating rod.

In preferred embodiments, the weight of the cut filler is between 25 milligrams and 150 milligrams, preferably between 30 milligrams and 125 milligrams, more preferably between 40 milligrams and 100 milligrams. This amount of cut filler typically allows for sufficient material for the formation of an aerosol during the early puffs.

Preferably, the cut filler is soaked with the aerosol former. Soaking the cut filler can be done by spraying or by other suitable application methods. The aerosol former may be applied to the blend during preparation of the cut filler. For example, the aerosol former may be applied to the blend in the direct conditioning casing cylinder (DCCC). Conventional machinery can be used for applying an aerosol former to the cut filler. Suitable aerosol formers are set out above.

Preferably, the aerosol former in the cut filler comprises one or more of glycerol and propylene glycol. The aerosol former may consist of glycerol or propylene glycol or of a combination of glycerol and propylene glycol.

In other preferred embodiments, the first aerosol-generating substrate comprises homogenised plant material, preferably a homogenised tobacco material.

As used herein, the term “homogenised plant material” encompasses any plant material formed by the agglomeration of particles of plant. For example, sheets or webs of homogenised tobacco material for the aerosol-generating substrates may be formed by agglomerating particles of tobacco material obtained by pulverising, grinding or comminuting plant material and optionally one or more of tobacco leaf lamina and tobacco leaf stems. The homogenised plant material may be produced by casting, extrusion, paper making processes or other any other suitable processes known in the art.

The homogenised plant material can be provided in any suitable form.

In some embodiments, the homogenised plant material may be in the form of one or more sheets. As used herein, the term “sheet” describes a laminar element having a width and length substantially greater than the thickness thereof.

The homogenised plant material may be in the form of a plurality of pellets or granules. The homogenised plant material may be in the form of a plurality of strands, strips or shreds. As used herein, the term “strand” describes an elongate element of material having a length that is substantially greater than the width and thickness thereof. The term “strand” should be considered to encompass strips, shreds and any other homogenised plant material having a similar form. The strands of homogenised plant material may be formed from a sheet of homogenised plant material, for example by cutting or shredding, or by other methods, for example, by an extrusion method.

Where the homogenised plant material is in the form of one or more sheets, as described above, the sheets may be produced by a casting process. Alternatively, sheets of homogenised plant material may be produced by a paper-making process.

The one or more sheets as described herein may each individually have a thickness of between 100 micrometres and 600 micrometres, preferably between 150 micrometres and 300 micrometres, and most preferably between 200 micrometres and 250 micrometres. Individual thickness refers to the thickness of the individual sheet, whereas combined thickness refers to the total thickness of all sheets that make up the aerosol-generating substrate.

The one or more sheets as described herein may each individually have a grammage of between 100 grams per square metre and 600 grams per square metre.

The one or more sheets as described herein may each individually have a density of from 0.3 grams per cubic centimetre to 1.3 grams per cubic centimetre, and preferably from 0.7 grams per cubic centimetre to 1.0 gram per cubic centimetre.

The one or more sheets as described herein may have been one or more of crimped, folded, gathered and pleated.

The one or more sheets of homogenised plant material may be cut into strands as referred to above. In such embodiments, the aerosol-generating substrate comprises a plurality of strands of the homogenised plant material. The strands may be used to form a plug. Typically, the width of such strands is about 5 millimetres, or about 4 millimetres, or about 3 millimetres, or about 2 millimetres or less. The length of the strands may be greater than about 5 millimetres, between about 5 millimetres to about 15 millimetres, about 8 millimetres to about 12 millimetres, or about 12 millimetres. Preferably, the strands have substantially the same length as each other.

The homogenised plant material may comprise between 2.5 percent and 95 percent by weight of plant particles, or between 5 percent and 90 percent by weight of plant particles, or between 10 percent and 80 percent by weight of plant particles, or between 15 percent and 70 percent by weight of plant particles, or between 20 percent and 60 percent by weight of plant particles, or between 30 percent and 50 percent by weight of plant particles, on a dry weight basis.

In certain embodiments, the homogenised plant material is a homogenised tobacco material comprising tobacco particles. Sheets of homogenised tobacco material for use in such embodiments may have a tobacco content of at least about 40 percent by weight on a dry weight basis, more preferably of at least about 50 percent by weight on a dry weight basis more preferably at least about 70 percent by weight on a dry weight basis and most preferably at least about 90 percent by weight on a dry weight basis.

The term “tobacco particles” may describe particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of this disclosure and are not included in the percentage of particulate plant material.

The second aerosol-generating substrate may comprise nicotine. As used herein, the term “nicotine” is used to describe nicotine, a nicotine base or a nicotine salt. In embodiments in which the second aerosol-generating substrate comprises a nicotine base or a nicotine salt, the amounts of nicotine recited herein are the amount of free base nicotine or amount of protonated nicotine, respectively.

Preferably, the second aerosol-generating substrate comprises at least 0.5 percent by weight of nicotine on a dry weight basis. More preferably, the second aerosol-generating substrate comprises at least 1 percent by weight of nicotine on a dry weight basis. Even more preferably, the second aerosol-generating substrate comprises at least 2 percent by weight of nicotine on a dry weight basis. In addition, or as an alternative, the second aerosol-generating substrate preferably comprises less than 10 percent by weight of nicotine on a dry weight basis. More preferably, the second aerosol-generating substrate comprises less than 8 percent by weight of nicotine on a dry weight basis. More preferably, the second aerosol-generating substrate comprises less than 6 percent by weight of nicotine on a dry weight basis.

For example, the second aerosol-generating substrate may comprise between 0.5 percent and 10 percent by weight of nicotine, or between 1 percent and 8 percent by weight of nicotine, or between 2 percent and 6 percent by weight of nicotine, on a dry weight basis.

The second aerosol-generating substrate may be substantially tobacco free.

The second aerosol-generating substrate may be in the form of cut filler, or a homogenised tobacco material, as described above.

Preferably, the second aerosol-generating substrate is in the form of an aerosol-generating film comprising a cellulosic based film forming agent, nicotine and the aerosol former. The aerosol-generating film may further comprise a cellulose based strengthening agent. The aerosol-generating film may further comprise water, preferably 30 percent by weight or less of water.

As used herein, the term “film” is used to describe a solid laminar element having a thickness that is less than the width or length thereof. The film may be self-supporting. In other words, a film may have cohesion and mechanical properties such that the film, even if obtained by casting a film-forming formulation on a support surface, can be separated from the support surface. Alternatively, the film may be disposed on a support or sandwiched between other materials. This may enhance the mechanical stability of the film.

The aerosol former content of the aerosol-generating film is within the ranges defined above for the second aerosol-generating substrate.

The term “cellulose based film-forming agent” is used to describe a cellulosic polymer capable, by itself or in the presence of an auxiliary thickening agent, of forming a continuous film.

Preferably, the cellulose based film-forming agent is selected from the group consisting of hydroxypropyl methylcellulose (HPMC), methylcellulose (MC), ethylcellulose (EC), hydroxyethyl methyl cellulose (HEMC), hydroxyethyl cellulose (HEC), hydroxypropyl cellulose (HPC), and combinations thereof.

More preferably, the cellulose based film-forming agent is selected from the group consisting of hydroxypropyl methylcellulose (HPMC), methylcellulose (MC), ethylcellulose (EC), and combinations thereof.

In particularly preferred embodiments, the cellulose based film-forming agent is HPMC.

The aerosol-generating film may have a cellulose based film-forming agent content of between 10 percent and 40 percent by weight, or between 15 percent and 35 percent by weight, or between 20 percent and 30 percent by weight, on a dry weight basis.

Preferably, the aerosol-generating film further comprises a cellulose based strengthening agent. Preferably, the cellulose based strengthening agent is selected from the group consisting of cellulose fibres, microcrystalline cellulose (MCC), cellulose powder, and combinations thereof.

The aerosol-generating film may have a cellulose based strengthening agent content of between 0.5 percent and 40 percent by weight on a dry weight basis, or between 5 percent and 30 percent by weight on a dry weight basis, or between 10 percent and 25 percent by weight on a dry weight basis.

The aerosol-generating film may further comprise a carboxymethyl cellulose, preferably sodium carboxymethyl cellulose.

The aerosol-generating film may have a carboxymethyl cellulose content of between 1 percent and 15 percent by weight, or between 2 percent and 12 percent by weight, or between 4 percent and 10 percent by weight on a dry weight basis.

The aerosol-generating film preferably comprises nicotine.

In embodiments in which the aerosol-generating film comprises a nicotine base or a nicotine salt, the amounts of nicotine recited herein are the amount of free base nicotine or amount of protonated nicotine, respectively.

The aerosol-generating film may comprise natural nicotine or synthetic nicotine.

The aerosol-generating film may comprise one or more monoprotic nicotine salts.

As used herein, the term “monoprotic nicotine salt” is used to describe a nicotine salt of a monoprotic acid.

Preferably, the aerosol-generating film comprises at least 0.5 percent by weight of nicotine on a dry weight basis. More preferably, the aerosol-generating film comprises at least 1 percent by weight of nicotine on a dry weight basis. Even more preferably, the aerosol-generating film comprises at least 2 percent by weight of nicotine on a dry weight basis. In addition, or as an alternative, the aerosol-generating film preferably comprises less than 10 percent by weight of nicotine on a dry weight basis. More preferably, the aerosol-generating film comprises less than 8 percent by weight of nicotine on a dry weight basis. More preferably, the aerosol-generating film comprises less than 6 percent by weight of nicotine on a dry weight basis.

For example, the aerosol-generating film may comprise between 0.5 percent and 10 percent by weight of nicotine, or between 1 percent and 8 percent by weight of nicotine, or between 2 percent and 6 percent by weight of nicotine, on a dry weight basis.

The aerosol-generating film may be a substantially tobacco-free aerosol-generating film.

In preferred embodiments, the aerosol-generating film comprises an acid. More preferably, the aerosol-generating film comprises one or more organic acids. Even more preferably, the aerosol-generating film comprises one or more carboxylic acids. In particularly preferred embodiments, the acid is lactic acid, benzoic acid, fumaric acid or levulinic acid.

Preferably, the aerosol-generating film comprises between 0.25 percent and 3.5 percent by weight of an acid, or between 0.5 percent and 3 percent by weight of an acid, or between 1 percent and 2.5 percent by weight of an acid, on a dry weight basis.

The aerosol-generating film may have a thickness from about 0.1 millimetres to about 1 millimetre, more preferably from about 0.1 millimetres to about 0.75 millimetres, even more preferably from about 0.1 millimetres to about 0.5 millimetres. In particularly preferred embodiments, a layer of the film-forming composition is formed that has a thickness from about 50 micrometres to 400 micrometres, more preferably from about 100 micrometres to 200 micrometres.

The aerosol-generating film may optionally be provided within the second aerosol-generating segment on a suitable carrier element.

In alternative embodiments, the second aerosol-generating substrate may comprise a gel composition that includes nicotine, at least one gelling agent and the aerosol former. The gel composition is preferably substantially tobacco free.

The preferred weight ranges for nicotine in the gel composition are the same as those defined above in relation to aerosol-generating films.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The gel composition preferably includes at least one gelling agent. Preferably, the gel composition includes a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The term “hydrogen-bond crosslinking gelling agent” refers to a gelling agent that forms non-covalent crosslinking bonds or physical crosslinking bonds via hydrogen bonding.

The hydrogen-bond crosslinking gelling agent may include one or more of a galactomannan, gelatin, agarose, or konjac gum, or agar. The hydrogen-bond crosslinking gelling agent may preferably include agar.

The term “ionic crosslinking gelling agent” refers to a gelling agent that forms non-covalent crosslinking bonds or physical crosslinking bonds via ionic bonding.

The ionic crosslinking gelling agent may include low acyl gellan, pectin, kappa carrageenan, iota carrageenan or alginate. The ionic crosslinking gelling agent may preferably include low acyl gellan.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

The gel composition may further include a viscosifying agent. The viscosifying agent combined with the hydrogen-bond crosslinking gelling agent and the ionic crosslinking gelling agent appears to surprisingly support the solid medium and maintain the gel composition even when the gel composition comprises a high level of glycerol.

The term “viscosifying agent” refers to a compound that, when added homogeneously into a 25 °C, 50 percent by weight water/50 percent by weight glycerol mixture, in an amount of 0.3 percent by weight., increases the viscosity without leading to the formation of a gel, the mixture staying or remaining fluid.

The gel composition preferably includes the viscosifying agent in a range from about 0.2 percent by weight to about 5 percent by weight, or from about 0.5 percent by weight to about 3 percent by weight, or from about 0.5 percent by weight to about 2 percent by weight, or from about 1 percent by weight to about 2 percent by weight.

The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may further include a divalent cation. Preferably the divalent cation includes calcium ions, such as calcium lactate in solution. Divalent cations (such as calcium ions) may assist in the gel formation of compositions that include gelling agents such as the ionic crosslinking gelling agent, for example. The ion effect may assist in the gel formation. The divalent cation may be present in the gel composition in a range from about 0.1 to about 1 percent by weight, or about 0.5 percent by weight t.

The gel composition may further include an acid. The acid may comprise a carboxylic acid. The carboxylic acid may include a ketone group. Preferably the carboxylic acid may include a ketone group having less than about 10 carbon atoms, or less than about 6 carbon atoms or less than about 4 carbon atoms, such as levulinic acid or lactic acid. Preferably this carboxylic acid has three carbon atoms (such as lactic acid).

The gel composition preferably comprises some water. The gel composition is more stable when the composition comprises some water.

Preferably the gel composition comprises between about 8 percent by weight to about 32 percent by weight water, or from about 15 percent by weight to about 25 percent by weight water, or from about 18 percent by weight to about 22 percent by weight water, or about 20 percent by weight water.

Preferably, where a gel composition is used, the second aerosol-generating substrate comprises a porous medium loaded with the gel composition. Advantages of a porous medium loaded with the gel composition is that the gel composition is retained within the porous medium, and this may aid manufacturing, storage or transport of the gel composition. It may assist in keeping the desired shape of the gel composition, especially during manufacture, transport, or use.

The term “porous” is used herein to refer to a material that provides a plurality of pores or openings that allow the passage of air through the material.

The porous medium may be any suitable porous material able to hold or retain the gel composition. Ideally the porous medium can allow the gel composition to move within it. In specific embodiments the porous medium comprises natural materials, synthetic, or semi-synthetic, or a combination thereof. In specific embodiments the porous medium comprises sheet material, foam, or fibres, for example loose fibres; or a combination thereof. In specific embodiments the porous medium comprises a woven, non-woven, or extruded material, or combinations thereof. Preferably the porous medium comprises, cotton, paper, viscose, PLA, or cellulose acetate, of combinations thereof. Preferably the porous medium comprises a sheet material, for example, cotton or cellulose acetate. In a particularly preferred embodiment, the porous medium comprises a sheet made from cotton fibres. The porous medium may be crimped or shredded. The porous medium may be in the form of a sheet, thread or tubular element.

Optionally, the aerosol-generating article comprises a frame, for example a planar frame. The frame may be a unitary component or may comprise a plurality of components. The frame may comprise or define, at least in part, the inlet. The frame may comprise or define, at least in part, the outlet. The frame may comprise or define, at least in part, the flow passage.

The article may comprise a ceiling. The frame may comprise the ceiling. The ceiling may be referred to as a top layer. The ceiling may be planar.

The article may comprise a base. The frame may comprise the base. The base may be referred to as a bottom layer. The base may be planar.

The article, for example the frame of the article, may comprise a front wall. The front wall may be an upstream wall and may be referred to as the upstream wall. The inlet may be defined in, for example be an aperture in, the front wall. The article, for example the frame of the article, may comprise a back wall. The back wall may be a downstream wall and may be referred to as the downstream wall. The outlet may be defined in, for example be an aperture in, the back wall. The front wall may oppose the back wall. The outlet may oppose the inlet. The article, for example the frame of the article, may comprise one or more side walls. The one or more side walls may comprise a left side wall and a right side wall. The left side wall and the right side wall may oppose one another. The one or more side walls may extend from the front wall to the back wall. Any two or more of the front wall, the back wall, the one or more side walls may be integral with one another. Advantageously, this structure may provide a robust article which is easy to manufacture.

The article, for example the frame of the article, may comprise or define, at least in part, a recess. The recess may be between the inlet and the outlet. The recess may be downstream of the inlet and upstream of the outlet. The front wall, back wall, and the one or more side walls may together encircle, or mostly encircle, for example surround by more than 270, 300, or 300 degrees in a single plane, the recess. The recess may be located between the front wall and the back wall. The recess may be located between the left wall and the right wall. The recess may be located between the ceiling and the base. Advantageously, the recess may provide a suitable space for the first and second aerosol-generating segments.

One or both of the first aerosol-generating segment and the second aerosol-generating segment may be located in the recess. The article, for example the frame of the article, may comprise or define an opening. The opening may be in the ceiling. Alternatively, the opening may be present because no ceiling is present. The opening may advantageously allow one or both of the first and second aerosol-generating segments to be inserted into, or removed from, the recess by a user.

The frame may comprise a biodegradable material. The frame may comprise a porous material. The frame may comprise cellulose material. The cellulose material may be one or more of: paper, cellulose acetate. The frame may comprise a fibrous material. The frame may comprise any one or more of: synthetic fibers, polyester, bonded polyolefin, polyethylene, terylene, polypropylene, biopolymer fibers, nylon fibers, and ceramic fibers. Advantageously, such materials may provide a good compromise between one or more of: cost, weight, strength, air permeability, ease of manufacturing, and environmental friendliness.

One or both of the article and frame may have a substantially parallelepiped shape. The frame may have a frame length, a frame width and a frame depth. The frame length may be bigger than each of the frame width and the frame depth. The inlet and outlet may be disposed on opposite ends of the frame length.

A ratio of the frame width to the frame thickness may be between about 3:1 and 30:1. A ratio of the frame length to the frame width may be between about 1:1 and 5:1. The frame may have a thickness of between about 1 millimetre and 3 millimetres. The frame may have a width of between about 10 millimetres and 30 millimetres. The frame may have a length of between about 30 millimetres and 50 millimetres.

Advantageously, such dimensions may provide an article which is small enough to be easily held between the fingers of a user but large enough to contain a sufficient amount of aerosol-generating substrate to satisfy a user during a usage session.

The base may have a base thickness. The base thickness may be less than the frame thickness, for example no more than half the frame thickness. The base may be fixed or hermetically sealed to the frame. The base may be fixed or hermetically sealed to one or more bottom surfaces of the frame, for example to one or more bottom surfaces of one or more walls of the frame.

The ceiling may have a ceiling thickness. The ceiling thickness may be less than the frame thickness, for example no more than half the frame thickness. The ceiling may be fixed or hermetically sealed to the frame wall. The ceiling may be fixed or hermetically sealed to one or more top surfaces of the frame, for example to one or more top surfaces of one or more walls of the frame.

Optionally, one or both of the first aerosol-generating segment and the second aerosol-generating segment is supported by the base. Optionally, one or both of the first aerosol-generating segment and the second aerosol-generating segment is arranged on the base. Optionally, one or both of the first aerosol-generating segment and the second aerosol-generating segment is fixed, for example adhered, to the base. The base may comprise an adhesive region, for example for this purpose. The adhesive region may be on an upper surface of the base.

One or both of the base and the ceiling may comprise a biodegradable material. One or both of the base and the ceiling may comprise a porous material. One or both of the base and the ceiling may comprise cellulose material. The cellulose material may be one or more of: paper, paper-based material, or cellulose acetate. One or both of the base and the ceiling may comprise a fibrous material. One or both of the base and the ceiling may comprise any one or more of: synthetic fibers, polyester, bonded polyolefin, polyethylene, terylene, polypropylene, biopolymer fibers, nylon fibers, and ceramic fibers. Advantageously, such materials may provide a good compromise between one or more of: cost, weight, strength, air permeability, ease of manufacturing, and environmental friendliness.

The inlet may have a length of between 5 and 30, preferably between 10 and 20, millimetres. The inlet may have a width of between 5 and 30, preferably between 10 and 20, millimetres. The inlet may have a depth of between 2 and 10 millimetres.

The outlet may have a length of between 5 and 30, preferably between 10 and 20, millimetres. The outlet may have a width of between 5 and 30, preferably between 10 and 20, millimetres. The outlet may have a depth of 2 and 10 millimetres.

A thickness of one or each of the first aerosol-generating segment and the second aerosol-generating segment may be less than the frame depth. Where the article, for example the frame, comprises the ceiling, a first space may be present between a top of the first aerosol-generating segment and a bottom of the ceiling. Where the article, for example the frame, comprises the ceiling, a second space may be present between a top of the second aerosol-generating segment and a bottom of the ceiling. In use, air may flow both through and over the first aerosol-generating segment. In use, air may flow both through and over the second aerosol-generating segment. In use, the first and second spaces may allow air to flow over the respective first and second aerosol-generating segments. These spaces may advantageously reduce a resistance to draw of the article. Alternatively, or in addition, these spaces may promote turbulence or mixing of various constituents of the aerosol generated in use.

The flow passage may be defined from the inlet, through the recess, to the outlet. The flow passage may include one or both of an empty space above the first aerosol-generating segment and an empty space above the second aerosol-generating segment.

According to a second aspect, there is provided an aerosol-generating system comprising an aerosol-generating article and an aerosol-generating device configured to engage with, and generate an aerosol from, the aerosol-generating article. The aerosol-generating article may be the article described above, for example the article of the first aspect.

As used herein, the term “aerosol-generating article” may refer to an article comprising an aerosol-generating substrate. The article may be heated in use to produce and deliver an inhalable aerosol to a consumer.

As used herein, the term “aerosol-generating substrate” may refer to a substrate capable of releasing volatile compounds upon heating, for example compounds which, in use, cool and condense to generate an aerosol.

As used herein, the term “aerosol-generating device” may refer to a device that, in use, interacts with, for example heats, an aerosol-generating substrate of an aerosol-generating article to generate an aerosol.

As used herein, the term “longitudinal”, when used in reference to an aerosol-generating article, may refer to a direction corresponding to a main longitudinal axis of the aerosol-generating article, which may extend between an upstream end and a downstream end of the aerosol-generating article.

As used herein, the term “transverse” may refer to the direction that is perpendicular to the longitudinal direction. Any reference to the “cross-section” of the aerosol-generating article or a component of the aerosol-generating article refers to the transverse cross-section unless stated otherwise.

As used herein, the term “length” may refer to a maximum dimension of a component of the aerosol-generating article in the longitudinal direction.

As used herein, the term “width” may refer to a maximum dimension of a component of the aerosol-generating article in a first direction perpendicular to the longitudinal direction.

As used herein, the term “thickness” may refer to a maximum dimension of a component of the aerosol-generating article in a second direction perpendicular to the longitudinal direction. The second or thickness direction may also be perpendicular to the first or width direction. The terms “thickness” and “depth” may be used interchangeably herein.

As used herein, the terms “upstream” and “downstream” may refer to the relative positions of elements, or portions of elements, in relation to the direction in which the air or aerosol is transported through the aerosol-generating article during use.

As used herein, the term “bulk density” may refer to bulk density on a dry weight basis, unless otherwise specified. The bulk density of an aerosol-generating substrate [or segment] can be calculated by measuring or otherwise determining the total dry weight of the aerosol-generating substrate [or segment] and dividing this by the volume of the aerosol-generating segment substrate [or segment].

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-generating substrate or aerosol-generating article. Suitable aerosol formers for inclusion in the first and second aerosol-generating substrates are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate. Glycerol may be particularly preferable as an aerosol former. Aerosol former contents described with respect to the first and second aerosol-generating substrates may equally be considered glycerol contents.

As used herein, the term “aerosol former content” may refer to aerosol former content in percent on a dry weight basis, unless otherwise specified. Indeed, all weight percentages referred to herein may refer to weight percentages on a dry weight basis, unless otherwise specified. The aerosol former content of the first aerosol-generating substrate is based on the weight of the first aerosol-generating substrate, and the aerosol former content of the second aerosol-generating substrate is based on the weight of the second aerosol-generating substrate.

As used herein, the term “planar” may refer to a feature generally formed in a single Euclidean plane and not wrapped around or otherwise conformed to fit a curved or other non-planar shape. A planar surface may extend in two dimensions in a single Euclidean plane. A planar object may extend in two dimensions in a single Euclidean plane substantially more than in a third dimension perpendicular to the plane. More specifically, a planar object may extend in a first dimension and a second dimension perpendicular to the first dimension at least two, five or ten times further than the object extends in a third dimension perpendicular to the first and second dimensions.

The invention is defined in the claims. However, below there is provided a non-exhaustive list of non-limiting examples. Any one or more of the features of these examples may be combined with any one or more features of another example, embodiment, or aspect described herein.
Ex1. An aerosol-generating article for use with an aerosol-generating device to generate an aerosol, the aerosol-generating article comprising:
   an inlet, an outlet, and a flow passage extending from the inlet to the outlet;
   a first aerosol-generating segment comprising a first aerosol-generating substrate, the first aerosol-generating segment being located in the flow passage; and
   a second aerosol-generating segment comprising a second aerosol-generating substrate, the second aerosol-generating segment being located in the flow passage,
wherein:
   the aerosol-generating article is a planar aerosol-generating article having a length, a width, and a thickness, the thickness being no more than 0.5 times the length and no more than 0.5 times the width; and
   the first aerosol-generating substrate has one or both of a lower aerosol former content and a lower bulk density than the second aerosol-generating substrate.
Ex2. An aerosol-generating article according to example Ex1, wherein the thickness is no more than 0.2 times the length and no more than 0.2 times the width.
Ex3. An aerosol-generating article according to any preceding example, wherein the aerosol former content of the first aerosol-generating substrate is at least 10 percent by weight on a dry weight basis.
Ex4. An aerosol-generating article according to any preceding example, wherein the aerosol former content of the first aerosol-generating substrate is no more than 30, 25 or 20 percent by weight on a dry weight basis.
Ex5. An aerosol-generating article according to any preceding example, wherein the aerosol former content of the first aerosol-generating substrate is between 10 and 30 percent by weight on a dry weight basis.
Ex6. An aerosol-generating article according to any preceding example, wherein the aerosol former content of the second aerosol-generating substrate is at least 40, 45, or 50 percent by weight on a dry weight basis.
Ex7. An aerosol-generating article according to any preceding example, wherein the aerosol former content of the second aerosol-generating substrate is no more than 80, 75 or 70 percent by weight on a dry weight basis.
Ex8. An aerosol-generating article according to any preceding example, wherein the aerosol former content of the second aerosol-generating substrate is between 40 and 80 percent by weight on a dry weight basis.
Ex9. An aerosol-generating article according to any preceding example, wherein the aerosol former content of the first aerosol-generating substrate is no more than 30 percent by weight on a dry weight basis, and the aerosol former content of the second aerosol-generating substrate is at least 40 percent by weight on a dry weight basis.
Ex10. An aerosol-generating article according to any preceding example, wherein the aerosol former content of the second aerosol-generating substrate is at least 1.1, 1.2, 1.5, 2 or 2.5 times the aerosol former content of the first aerosol-generating substrate by weight on a dry weight basis.
Ex11. An aerosol-generating article according to any preceding example, wherein the first aerosol-generating substrate has a bulk density of at least 100, 150 or 200 milligrams per cubic centimetre.
Ex12. An aerosol-generating article according to any preceding example, wherein the first aerosol-generating substrate has a bulk density of no more than 400, 350 or 300 milligrams per cubic centimetre.
Ex13. An aerosol-generating article according to any preceding example, wherein the first aerosol-generating substrate has a bulk density of between 100 and 400 milligrams per cubic centimetre.
Ex14. An aerosol-generating article according to any preceding example, wherein the second aerosol-generating substrate has a bulk density of at least 500, 550 or 600 milligrams per cubic centimetre.
Ex15. An aerosol-generating article according to any preceding example, wherein the second aerosol-generating substrate has a bulk density of no more than 1000 or 800 milligrams per cubic centimetre.
Ex16. An aerosol-generating article according to any preceding example, wherein the second aerosol-generating substrate has a bulk density of between 500 and 1000 milligrams per cubic centimetre.
Ex17. An aerosol-generating article according to any preceding example, wherein the first aerosol-generating substrate has a bulk density of less than 400 milligrams per cubic centimetre, and the second aerosol-generating substrate has a bulk density of at least 500 milligrams per cubic centimetre.
Ex18. An aerosol-generating article according to any preceding example, wherein one or both of: the bulk density of the second aerosol-generating substrate is at least 1.1, 1.2, 1.5, 2 or 2.5 times the bulk density of the first aerosol-generating substrate; and the bulk density of the second aerosol-generating substrate is at least 20, 50, 100, or 200 grams per cubic centimetre greater the bulk density of the first aerosol-generating substrate.
Ex19. An aerosol-generating article according to any preceding example, wherein the first aerosol-generating substrate has both a lower aerosol former content and a lower bulk density than the second aerosol-generating substrate.
Ex20. An aerosol-generating article according to any preceding example, wherein: the aerosol former content of the second aerosol-generating substrate is at least 1.1 times the aerosol former content of the first aerosol-generating substrate by weight on a dry weight basis; and the bulk density of the second aerosol-generating substrate is at least 1.1 times the bulk density of the first aerosol-generating substrate.
Ex21. An aerosol-generating article according to any preceding example, wherein: the aerosol former content of the second aerosol-generating substrate is at least 1.2 times the aerosol former content of the first aerosol-generating substrate by weight on a dry weight basis; and the bulk density of the second aerosol-generating substrate is at least 1.2 times the bulk density of the first aerosol-generating substrate.
Ex22. An aerosol-generating article according to any preceding example, wherein: the aerosol former content of the second aerosol-generating substrate is at least 1.5 times the aerosol former content of the first aerosol-generating substrate by weight on a dry weight basis; and the bulk density of the second aerosol-generating substrate is at least 1.5 times the bulk density of the first aerosol-generating substrate.
Ex23. An aerosol-generating article according to any preceding example, wherein: the aerosol former content of the second aerosol-generating substrate is at least 2 times the aerosol former content of the first aerosol-generating substrate by weight on a dry weight basis; and the bulk density of the second aerosol-generating substrate is at least 2 times the bulk density of the first aerosol-generating substrate.
Ex24. An aerosol-generating article according to any preceding example, wherein: the aerosol former content of the second aerosol-generating substrate is at least 2.5 times the aerosol former content of the first aerosol-generating substrate by weight on a dry weight basis; and the bulk density of the second aerosol-generating substrate is at least 2.5 times the bulk density of the first aerosol-generating substrate.
Ex25. An aerosol-generating article according to any preceding example, wherein: the aerosol former content of the first aerosol-generating substrate is no more than 30 percent by weight on a dry weight basis, and the aerosol former content of the second aerosol-generating substrate is at least 40 percent by weight on a dry weight basis; and the first aerosol-generating substrate has a bulk density of less than 400 milligrams per cubic centimetre, and the second aerosol-generating substrate has a bulk density of at least 500 milligrams per cubic centimetre.
Ex26. An aerosol-generating article according to any preceding example, wherein: the aerosol former content of the first aerosol-generating substrate is no more than 25 percent by weight on a dry weight basis, and the aerosol former content of the second aerosol-generating substrate is at least 45 percent by weight on a dry weight basis; and the first aerosol-generating substrate has a bulk density of less than 350 milligrams per cubic centimetre, and the second aerosol-generating substrate has a bulk density of at least 550 milligrams per cubic centimetre.
Ex27. An aerosol-generating article according to any preceding example, wherein: the aerosol former content of the first aerosol-generating substrate is no more than 20 percent by weight on a dry weight basis, and the aerosol former content of the second aerosol-generating substrate is at least 50 percent by weight on a dry weight basis; and the first aerosol-generating substrate has a bulk density of less than 300 milligrams per cubic centimetre, and the second aerosol-generating substrate has a bulk density of at least 600 milligrams per cubic centimetre.
Ex28. An aerosol-generating article according to any preceding example, wherein at least a portion of the second aerosol-generating segment is located at a location upstream of at least a portion of the first aerosol-generating segment.
Ex29. An aerosol-generating article according to any preceding example, wherein the second aerosol-generating segment is located at a location upstream of the first aerosol-generating segment.
Ex30. An aerosol-generating article according to any preceding example, wherein an entirety of the second aerosol-generating segment is located at a location upstream of an entirety of the first aerosol-generating segment.
Ex31. An aerosol-generating article according to any preceding example, wherein the second aerosol-generating segment is spaced from, for example upstream of, the first aerosol-generating segment by at least 0.5, 1 or 2 millimetres.
Ex32. An aerosol-generating article according to any preceding example, wherein the second aerosol-generating segment is spaced from, for example upstream of, the first aerosol-generating segment by no more than 10, 5 or 2 millimetres.
Ex33. An aerosol-generating article according to any preceding example, wherein the second aerosol-generating segment is spaced from, for example upstream of, the first aerosol-generating segment by between 0.5 and 2 millimetres.
Ex34. An aerosol-generating article according to any preceding example, wherein one or both of the first aerosol-generating segment and the second aerosol-generating segment is planar.
Ex35. An aerosol-generating article according to any preceding example, wherein one or both of the first aerosol-generating segment and the second aerosol-generating segment is prismatic in shape, for example cuboid or right cylindrical in shape.
Ex36. An aerosol-generating article according to any preceding example, wherein the first aerosol-generating segment and the second aerosol-generating segment are identical in shape.
Ex37. An aerosol-generating article according to any preceding example, wherein one or both of the first aerosol-generating segment and the second aerosol-generating segment has a length at least 2, 5, or 10 times its thickness, or a width at least 2, 5, or 10 times its thickness, or both a length and a width at least 2, 5, or 10 times its thickness.
Ex38. An aerosol-generating article according to any preceding example, wherein one or both of the first aerosol-generating segment and the second aerosol-generating segment has a thickness of at least 0.05, 0.1, or 0.2 millimetres.
Ex39. An aerosol-generating article according to any preceding example, wherein one or both of the first aerosol-generating segment and the second aerosol-generating segment has a thickness no more than 5, 4, or 3 millimetres.
Ex40. An aerosol-generating article according to any preceding example, wherein one or both of the first aerosol-generating segment and the second aerosol-generating segment has a thickness of between 0.1 and 5 millimetres.
Ex41. An aerosol-generating article according to any preceding example, wherein one or both of the first aerosol-generating segment and the second aerosol-generating segment has a width of at least 5 or 10 millimetres.
Ex42. An aerosol-generating article according to any preceding example, wherein one or both of the first aerosol-generating segment and the second aerosol-generating segment has a width no more than 30 or 20 millimetres.
Ex43. An aerosol-generating article according to any preceding example, wherein one or both of the first aerosol-generating segment and the second aerosol-generating segment has a width of between 10 and 20 millimetres.
Ex44. An aerosol-generating article according to any preceding example, wherein one or both of the first aerosol-generating segment and the second aerosol-generating segment has a length of at least 5 or 10 millimetres.
Ex45. An aerosol-generating article according to any preceding example, wherein one or both of the first aerosol-generating segment and the second aerosol-generating segment has a length no more than 30 or 20 millimetres.
Ex46. An aerosol-generating article according to any preceding example, wherein one or both of the first aerosol-generating segment and the second aerosol-generating segment has a length of between 10 and 20 millimetres.
Ex47. An aerosol-generating article according to any preceding example, wherein the aerosol-generating article comprises a frame defining a recess.
Ex48. An aerosol-generating article according to example Ex47, wherein one or both of the first aerosol-generating segment and the second aerosol-generating segment is located in the recess.
Ex49. An aerosol-generating article according to example Ex47 or Ex48, wherein the frame comprises a planar base.
Ex50. An aerosol-generating article according to any of examples Ex1 to Ex47, wherein the aerosol-generating article comprises a planar base.
Ex51. An aerosol-generating article according to example Ex49 or Ex50, wherein one or both of the first aerosol-generating segment and the second aerosol-generating segment is supported by, for example fixed to, the planar base.
Ex52. An aerosol-generating system comprising an aerosol-generating article according to any preceding example and an aerosol-generating device configured to engage with, and generate an aerosol from, the aerosol-generating article.
Ex53. An aerosol-generating system according to example Ex52, wherein the system, for example the device, comprises a planar heating surface configured to heat one or both of the first and second aerosol-generating segments.
Ex54. An aerosol-generating system according to example Ex53, wherein the planar heating surface is configured to be positioned, during use, adjacent to, and parallel with, one or both of: a surface of the first aerosol-generating segment defined by a length and a width of the first aerosol-generating segment; and a surface of the second aerosol-generating segment defined by a length and a width of the second aerosol-generating segment.

Examples will now be further described with reference to the figures in which:

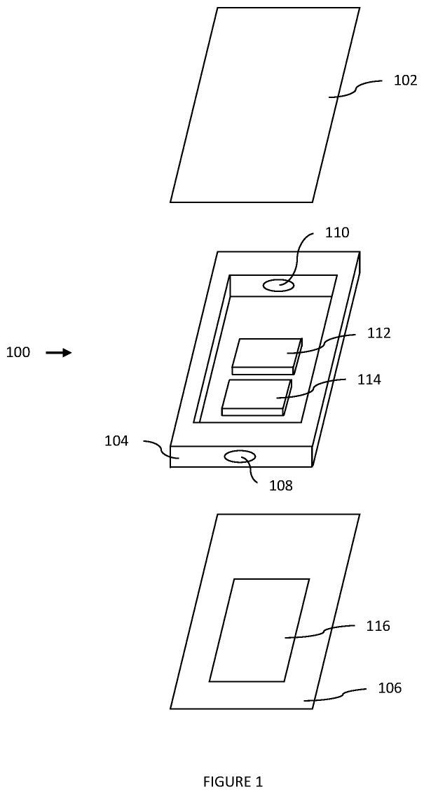

FIG. 1 shows an exploded view of an aerosol-generating article; and

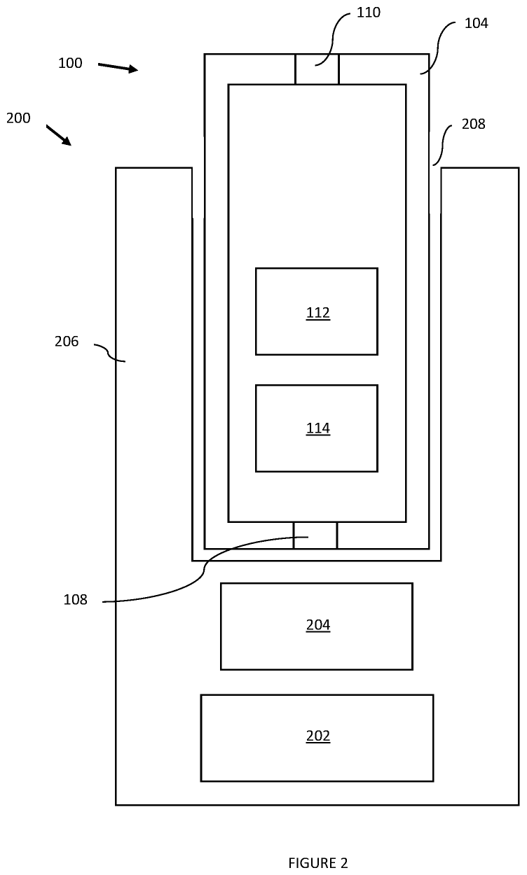

FIG. 2 shows a schematic, cross-sectional view of an aerosol-generating system comprising the aerosol-generating article of FIG. 1.

FIG. 1 shows an exploded view of an aerosol-generating article 100. The aerosol-generating article 100 is for use with an aerosol-generating device to generate an aerosol.

The aerosol-generating article 100 is a planar aerosol-generating article having a length, a width, and a thickness. The length is 40 millimetres, the width is 20 millimetres, and the thickness is 3 millimetres.

The aerosol-generating article 100 comprises a ceiling 102, a frame 104, and a base 106. The ceiling 102, frame 104, and base 106 each have a length of 40 millimetres and a width of 20 millimetres. The ceiling 102 and base 106 each have a thickness of 0.1 millimetres and the frame 104 has a thickness of 2.8 millimetres.

In this embodiment, the ceiling 102 and base 106 are formed from a plastic such as polytetrafluoroethylene, and the frame is formed from cellulose acetate. However, any suitable materials could be used.

The frame 104 comprises a cuboid-shaped perimeter wall defining a recess and is positioned between the ceiling 102 and the base 106. The perimeter wall may be considered to comprise a front wall, a back wall, a left wall and a right wall, all integral with one another and encircling the recess. The frame 104 defines an inlet 108 in the front wall at a first longitudinal end and an outlet 110 in the back wall at a second longitudinal end, opposite to the first longitudinal end. The inlet 108 and outlet 110 are apertures in the front and back walls, respectively. A flow passage extends from the inlet 102, through the recess encircled by the perimeter wall and between a lower surface of the ceiling 102 and an upper surface of the base 106, and to the outlet 104.

A lower surface of the ceiling 102 is adhered to an upper surface of the perimeter wall of the frame 104 and an upper surface of the base 106 is adhered to a lower surface of the perimeter wall of the frame 104.

The aerosol-generating article 100 also comprises a first aerosol-generating segment 112 comprising a first aerosol-generating substrate, the first aerosol-generating segment being located in the flow passage; and a second aerosol-generating segment 114 comprising a second aerosol-generating substrate, the second aerosol-generating segment also being located in the flow passage.

The first and second aerosol-generating segments 112, 114 each have a length of 10 millimetres, a width of 10 millimetres, and a thickness of 2 millimetres. The first and second aerosol-generating segments 112, 114 are positioned in the recess defined by the frame 104, between the ceiling 102 and the base 104.

The base 104 comprises an adhesive region 116. The first and second aerosol-generating segments 112, 114 are adhered to the adhesive region 116 on the base. In this embodiment, polyvinyl acetate is used as an adhesive. But any suitable adhesive could be used.

The first aerosol-generating segment 112 is located entirely downstream of the second aerosol-generating segment 114 and is spaced longitudinally from the second aerosol-generating segment 114 by about 1.5 millimetres.

The first aerosol-generating substrate is formed of about 60 mg of shredded tobacco material comprising between 15 percent by weight and 20 percent by weight of an aerosol former, in this case glycerol. The bulk density of the first aerosol-generating substrate is about 300 mg per cubic centimetre. The first aerosol-generating segment 112 is individually wrapped by a plug wrap (not shown).

The second aerosol-generating substrate is formed of about 120 mg of shreds of an aerosol-generating film. Example compositions A and B for the aerosol-generating film are shown below in Table 1 with weight percent being on a dry weight basis:

TABLE 1
aerosol-generating film compositions

| | Composition A | Composition B |
|---|---|---|
| Component | Amount (% by weight) | Amount (% by weight) |
| HPMC | 22.39 | 23.71 |
| Cellulose fibres | 16.79 | 0 |
| Cellulose powder | 0 | 17.79 |
| Sodium | 5.60 | 5.93 |
| carboxymethylcellulose | | |
| Nicotine | 1.40 | 1.48 |
| Glycerol | 50.37 | 47.43 |
| Lactic acid | 3.45 | 3.66 |

The second aerosol-generating substrate has far more glycerol, and thus a far greater aerosol former content, than the first aerosol-generating substrate. The bulk density of the second aerosol-generating substrate is around 600 mg per cubic centimetre. The second aerosol-generating segment 114 is also individually wrapped by a plug wrap (not shown).

The first aerosol-generating substrate thus has both a lower aerosol former content and a lower bulk density than the second aerosol-generating substrate.

FIG. 2 shows a schematic, cross-sectional view of an aerosol-generating system comprising the aerosol-generating article 100 of FIG. 1 and an aerosol-generating device 200.

The aerosol-generating device 200 comprises a battery 202, control electronics 204, and a housing 206 at least partially defining a chamber 208 for receiving the article 100.

One of the walls of the chamber 208 is defined by a planar, electrically resistive heating element (not shown). The heating element comprises an electrically insulating substrate, an electrically resistive heating track located on an inward-facing surface (i.e., a surface facing into the chamber) of the electrically insulating substrate, and a protective glass coating around the electrically insulating substrate and electrically resistive heating track. The electrically resistive heating track follows a serpentine path over a majority of the inward-facing surface of the electrically insulating substrate such that, when heated, most of an inward-facing surface of the heating element reaches a similar temperature.

In use, a user places the article 100 into the chamber 208 of the device 200, as shown in FIG. 2. In this position, an outer surface of the base 106 abuts the inward-facing surface of the heating element.

Then, a user may press a button (not shown) on the device 200 to start heating of the heating element, and then begin puffing on the article 100, specifically drawing on the outlet 110. In response to the button being pressed, the control electronics 204 supply a current from the battery 202 to the electrically resistive heating track, causing the track to heat up to around 250 degrees Celsius. This heats the nearby aerosol-generating substrates of the article 100.

The first aerosol-generating substrate, which has both a lower aerosol former content and a lower bulk density than the second aerosol-generating substrate, heats up to a sufficient temperature to generate an aerosol quickly. This is because it has a low thermal inertia. Thus, air flows into the article through the inlet 108, then through or over the second aerosol-generating segment 114 which, at this early stage of the usage session, may not have reached a sufficiently high temperature to generate an aerosol, then through or over the first aerosol-generating segment 112, which is generating an aerosol, then through the outlet 110 to the user. The air, when passing through or over the first aerosol-generating segment 112, entrains volatile compounds released by the heating of the first aerosol-generating substrate. These compounds cool and condense to form an aerosol, and then that aerosol is delivered to the user through the outlet 110.

The vast majority, if not all, of the first aerosol-generating substrate is heated to a sufficient temperature to generate an aerosol since it is relatively thin in a direction extending away from the heating element.

As the usage session continues and the user continues puffing on the article 100, the first aerosol-generating substrate depletes relatively quickly. However, by the time the first aerosol-generating substrate is depleted, the second aerosol-generating substrate has reached a temperature sufficient to generate an aerosol. Thus, the usage session can continue. The low bulk density of the first aerosol-generating substrate, downstream of the second aerosol-generating substrate, also advantageously means that the first aerosol-generating substrate does not provide a high level of filtration, or largely increase a resistance to draw, as aerosol from the second aerosol-generating substrate flows through or past the first aerosol-generating substrate.

Eventually, the second aerosol-generating substrate may be depleted and the user may press the button again to cease power supply to the heating element and end the usage session. The user may then dispose of the article 100.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article for an aerosol-generating device to generate an aerosol, the aerosol-generating article comprising:
an inlet, an outlet, and a flow passage extending from the inlet to the outlet;
a first aerosol-generating segment comprising a first aerosol-generating substrate, the first aerosol-generating segment being located in the flow passage; and
a second aerosol-generating segment comprising a second aerosol-generating substrate, the second aerosol-generating segment being located in the flow passage,
wherein the aerosol-generating article is a planar aerosol-generating article having a length, a width, and a thickness, the thickness being no more than 0.5 times the length and no more than 0.5 times the width,
wherein at least a portion of the second aerosol-generating segment is located upstream of at least a portion of the first aerosol-generating segment, and
wherein one or both of: an aerosol former content of the second aerosol-generating substrate is at least 1.1 times an aerosol former content of the first aerosol-generating substrate by weight on a dry weight basis and a bulk density of the second aerosol-generating substrate is at least 1.1 times a bulk density of the first aerosol-generating substrate.

17. The aerosol-generating article according to claim 16, wherein the aerosol former content of the second aerosol-generating substrate is at least 1.1 times the aerosol former content of the first aerosol-generating substrate by weight on a dry weight basis.

18. The aerosol-generating article according to claim 16, wherein, by weight on a dry weight basis, the aerosol former content of the second aerosol-generating substrate is X percent and the aerosol former content of the first aerosol-generating substrate is Y percent, and X is at least 10 greater than Y.

19. The aerosol-generating article according to claim 16, wherein the aerosol former content of the first aerosol-generating substrate is no more than 30 percent by weight on a dry weight basis, and the aerosol former content of the second aerosol-generating substrate is at least 40 percent by weight on a dry weight basis.

20. The aerosol-generating article according to claim 16, wherein the bulk density of the second aerosol-generating substrate is at least 1.1 times the bulk density of the first aerosol-generating substrate.

21. The aerosol-generating article according to claim 16, wherein the bulk density of the second aerosol-generating substrate is at least 50 milligrams per cubic centimetre greater than the bulk density of the first aerosol-generating substrate.

22. The aerosol-generating article according to claim 16, wherein the first aerosol-generating substrate has a bulk density of less than 400 milligrams per cubic centimetre, and the second aerosol-generating substrate has a bulk density of at least 500 milligrams per cubic centimetre.

23. The aerosol-generating article according to claim 16, wherein the first aerosol-generating substrate has both a lower aerosol former content and a lower bulk density than the second aerosol-generating substrate.

24. The aerosol-generating article according to claim 16,
wherein the aerosol former content of the second aerosol-generating substrate is at least 1.1 times the aerosol former content of the first aerosol-generating substrate by weight on a dry weight basis, and
wherein the bulk density of the second aerosol-generating substrate is at least 1.1 times the bulk density of the first aerosol-generating substrate.

25. The aerosol-generating article according to claim 16,
wherein, by weight on a dry weight basis, the aerosol former content of the second aerosol-generating substrate is X percent and the aerosol former content of the first aerosol-generating substrate is Y percent, and X is at least 10 greater than Y, and
wherein the bulk density of the second aerosol-generating substrate is at least 50 milligrams per cubic centimetre greater than the bulk density of the first aerosol-generating substrate.

26. The aerosol-generating article according to claim 16,
wherein the aerosol former content of the first aerosol-generating substrate is no more than 30 percent by weight on a dry weight basis, and the aerosol former content of the second aerosol-generating substrate is at least 40 percent by weight on a dry weight basis, and
wherein the first aerosol-generating substrate has a bulk density of less than 400 milligrams per cubic centimetre, and the second aerosol-generating substrate has a bulk density of at least 500 milligrams per cubic centimetre.

27. The aerosol-generating article according to claim 16, wherein an entirety of the second aerosol-generating segment is located upstream of an entirety of the first aerosol-generating segment.

28. The aerosol-generating article according to claim 16, wherein the second aerosol-generating segment is spaced from the first aerosol-generating segment by between 0.5 millimetre and 5 millimetres.

29. The aerosol-generating article according to claim 16,
further comprising a base and a ceiling opposing the base,
wherein one or both of:
the first aerosol-generating segment is arranged on the base and at least a portion of the flow passage is located between the ceiling and the first aerosol-generating segment, and
the second aerosol-generating segment is arranged on the base and at least a portion of the flow passage is located between the ceiling and the second aerosol-generating segment.

30. An aerosol-generating system comprising the aerosol-generating article according to claim 16 and an aerosol-generating device configured to engage with, and generate an aerosol from, the aerosol-generating article.
